(19) United States
(12) Patent Application Publication
(10) Pub. No.: US 2025/0355020 A1
(43) Pub. Date: Nov. 20, 2025

(54) SENSOR AND ELECTRONIC DEVICE

(71) Applicant: KABUSHIKI KAISHA TOSHIBA, Tokyo (JP)

(72) Inventors: Hideaki MURASE, Yokohama (JP); Daiki ONO, Yokohama (JP); Fumito MIYAZAKI, Kawasaki (JP); Yasushi TOMIZAWA, Tokyo (JP)

(73) Assignee: KABUSHIKI KAISHA TOSHIBA, Tokyo (JP)

(21) Appl. No.: 19/034,760

(22) Filed: Jan. 23, 2025

(30) Foreign Application Priority Data
May 20, 2024 (JP) 2024-081550

(51) Int. Cl. G01P 15/135; G01P 3/44; G01P 15/08; G01P 15/125

(52) U.S. Cl. CPC G01P 15/135; G01P 3/44; G01P 15/125; G01P 2015/0865

(57) ABSTRACT

According to one embodiment, According to one embodiment, a sensor includes a first element portion, and a first circuit portion. The first element portion includes a first base, a first fixed portion, a first movable portion, first to fourth fixed electrodes. The first movable portion includes first to fourth movable electrodes. The first circuit portion includes a controller. The controller is configured to perform a first operation. The first operation includes deriving a first value corresponding to a vibration direction of the first movable portion based on a first signal obtained from the first fixed electrode and a second signal obtained from the second fixed electrode. The first operation includes synchronously detecting a first function value of the first value and a second function value of the first value.

### CROSS-REFERENCE TO RELATED APPLICATIONS

This application is based upon and claims the benefit of priority from Japanese Patent Application No. 2024-081550, filed on May 20, 2024; the entire contents of which are incorporated herein by reference.

### FIELD

Embodiments described herein relate generally to a sensor and an electronic device.

### BACKGROUND

For example, there are sensors using MEMS (Micro Electro Mechanical Systems) elements. It is desired to improve the accuracy of sensors.

### BRIEF DESCRIPTION OF THE DRAWINGS

FIG. 1 is a schematic diagram illustrating a sensor according to a first embodiment;

FIGS. 2A and 2B are schematic cross-sectional views illustrating a part of the sensor according to the first embodiment;

FIG. 3 is a schematic diagram illustrating a part of the sensor according to the first embodiment;

FIGS. 4A and 4B are graphs illustrating the operation of the sensor according to the first embodiment;

FIG. 5 is a schematic diagram illustrating a part of a sensor according to the first embodiment;

FIG. 6 is a schematic plan view illustrating a part of a sensor according to the first embodiment;

FIG. 7 is a schematic diagram illustrating an electronic device according to a second embodiment;

FIGS. 8A to 8H are schematic views illustrating applications of the electronic device according to the embodiment; and

FIGS. 9A and 9B are schematic views illustrating applications of the sensor according to the embodiment.

### DETAILED DESCRIPTION

According to one embodiment, a sensor includes a first element portion, and a first circuit portion. The first element portion includes a first base, a first fixed portion fixed to the first base, a first movable portion, a first fixed electrode, a second fixed electrode, and a fourth fixed electrode. The first movable portion is supported by the first fixed portion. A first gap is provided between the first base and the first movable portion. The first movable portion includes a first movable electrode, a second movable electrode, a third movable electrode, and a fourth movable electrode. The first fixed electrode is fixed to the first base and faces the first movable electrode. The second fixed electrode is fixed to the first base and faces the second movable electrode. The third fixed electrode is fixed to the first base and faces the third movable electrode. The fourth fixed electrode is fixed to the first base and faces the fourth movable electrode. A second direction from the first fixed electrode to the first fixed portion crosses a first direction from the first base to the first fixed portion. A third direction from the second fixed electrode to the first fixed portion crosses the first direction and crosses the second direction. A direction from the first fixed portion to the third fixed electrode is along the second direction. A direction from the first fixed portion to the fourth fixed electrode is along the third direction. The first circuit portion includes a controller. The controller is configured to perform a first operation. The first operation includes deriving a first value corresponding to a vibration direction of the first movable portion based on a first signal obtained from the first fixed electrode and a second signal obtained from the second fixed electrode. The first operation includes synchronously detecting a first function value of the first value and a second function value of the first value.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

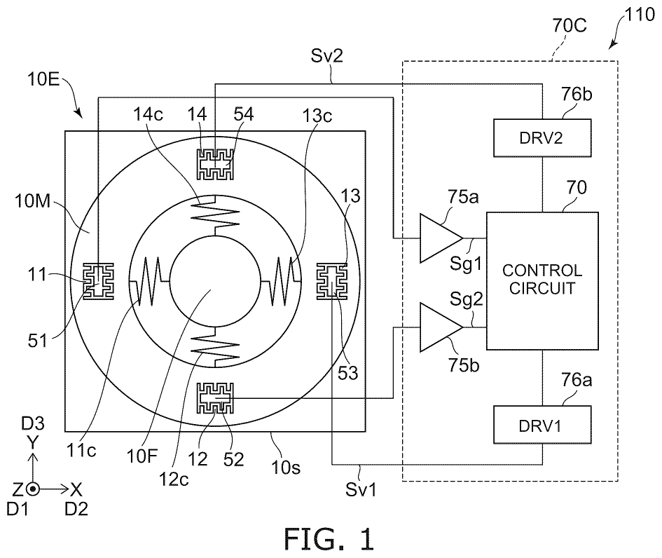

FIG. 1 is a schematic diagram illustrating a sensor according to a first embodiment.

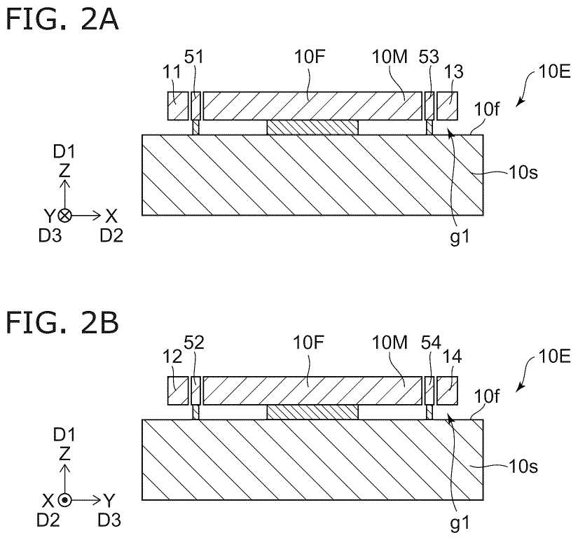

FIGS. 2A and 2B are schematic cross-sectional views illustrating a part of the sensor according to the first embodiment.

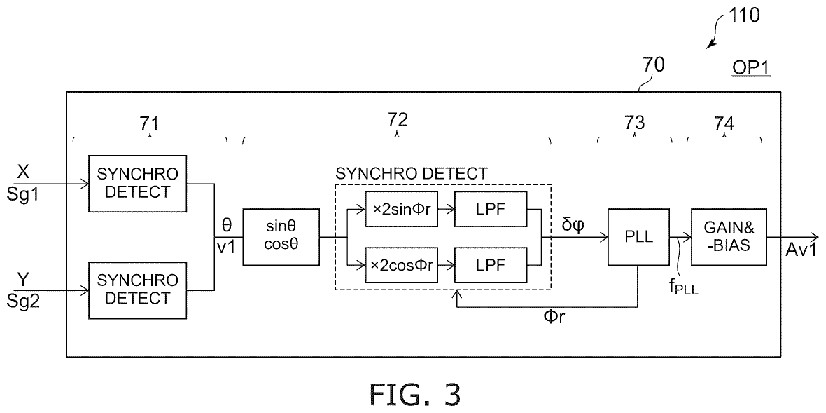

FIG. 3 is a schematic diagram illustrating a part of the sensor according to the first embodiment.

As shown in FIG. 1, a sensor 110 according to the embodiment includes a first element portion 10E and a first circuit portion 70C.

As shown in FIGS. 1, 2A, and 2B, the first element portion 10E includes a first base 10s, a first fixed portion 10F, a first movable portion 10M, a first fixed electrode 51, a second fixed electrode 52, a third fixed electrode 53, and a fourth fixed electrode 54.

The first fixed portion 10F is fixed to the first base 10s. The first movable portion 10M is supported by the first fixed portion 10F. A first gap g1 is provided between the first base 10s and the first movable portion 10M.

The first movable portion 10M may include a first movable electrode 11, a second movable electrode 12, a third movable electrode 13, and a fourth movable electrode 14.

The first fixed electrode 51 is fixed to the first base 10s and faces the first movable electrode 11. The second fixed electrode 52 is fixed to the first base 10s and faces the second movable electrode 12. The third fixed electrode 53 is fixed to the first base 10s and faces the third movable electrode 13. The fourth fixed electrode 54 is fixed to the first base 10s and faces the fourth movable electrode 14.

A second direction D2 from the first fixed electrode 51 to the first fixed portion 10F crosses a first direction D1 from the first base 10s to the first fixed portion 10F. A third direction D3 from the second fixed electrode 52 to the first fixed portion 10F crosses the first direction D1 and crosses the second direction D2.

The first direction D1 is the Z-axis direction. One direction perpendicular to the Z-axis direction is defined as the X-axis direction. The direction perpendicular to the Z-axis direction and the X-axis direction is defined as the Y-axis direction. The second direction D2 may be, for example, the X-axis direction. In one example, the third direction D3 may be substantially perpendicular to the second direction D2. For example, the third direction D3 may be the Y-axis direction.

A direction from the first fixed portion 10F to the third fixed electrode 53 is along the second direction D2. A direction from the first fixed portion 10F to the fourth fixed electrode 54 is along the third direction D3.

As shown in FIG. 1, the first element portion 10E may further include a first connecting portion 11c, a second connecting portion 12c, a third connecting portion 13c, and a fourth connecting portion 14c. The first connecting portion 11c is supported by the first fixed portion 10F and supports the first movable portion 10M. The second connecting portion 12c is supported by the first fixed portion 10F and supports the first movable portion 10M. The third connecting portion 13c is supported by the first fixed portion 10F and supports the first movable portion 10M. The fourth connecting portion 14c is supported by the first fixed portion 10F and supports the first movable portion 10M.

The first connecting portion 11c is located between the first fixed portion 10F and the first movable portion 10M in the second direction D2. The second connecting portion 12c is located between the first fixed portion 10F and the first movable portion 10M in the third direction D3. The third connecting portion 13c is located between the first fixed portion 10F and the first movable portion 10M in the second direction D2. The fourth connecting portion 14c is located between the first fixed portion 10F and the first movable portion 10M in the third direction D3.

The first connecting portion 11c, the second connecting portion 12c, the third connecting portion 13c, and the fourth connecting portion 14c may have a meandering structure, for example. The first movable portion 10M is easily to vibrate.

As shown in FIG. 1, for example, the first circuit portion 70C may include a first drive circuit 76a and a second drive circuit 76b. The first drive circuit 76a is configured to supply a first drive signal Sv1 to the third fixed electrode 53. The second drive circuit 76b is configured to supply a second drive signal Sv2 to the fourth fixed electrode 54.

The first movable portion 10M is configured to vibrate in accordance with the first drive signal Sv1 and the second drive signal Sv2.

As shown in FIG. 1, the first circuit portion 70C may include a first detection circuit 75a and a second detection circuit 75b. The first detection circuit 75a is electrically connected to the first fixed electrode 51. The first detection circuit 75a is configured to output a first signal Sg1. The second detection circuit 75b is electrically connected to the second fixed electrode 52. The second detection circuit 75b is configured to output a second signal Sg2.

The first signal Sg1 corresponds to a component of the vibration of the first movable portion 10M along the second direction D2. The second signal Sg2 corresponds to a component of the vibration of the first movable portion 10M along the third direction D3.

In the embodiment, for example, the state of vibration of the first movable portion 10M changes due to the influence of external angular velocity that the first movable portion 10M receives. For example, by detecting the state of vibration of the first movable portion 10M, the external angular velocity can be detected. The first element portion 10E is, for example, an angular velocity sensor. The first element portion 10E is, for example, a gyro sensor.

In the embodiment, the first circuit portion 70C may vibrate the first movable portion 10M so that the vibration direction of the first movable portion 10M changes with time. An angle θ of the vibration direction of the first movable portion 10M may change linearly with respect to time, for example. For example, “virtual rotation mode operation” may be implemented.

For example, the first drive circuit 76a and the second drive circuit 76b may supply the first drive signal Sv1 and the second drive signal Sv2 that apply a rotational force to the first movable portion 10M to rotate the vibration direction (change the angle θ). The operations of the first drive circuit 76a and the second drive circuit 76b may be controlled by a controller 70 (see FIG. 1) provided in the first circuit portion 70C.

For example, the first circuit portion 70C includes the controller 70. The controller 70 is configured to perform a first operation OP1. FIG. 3 illustrates the first operation OP1 in the sensor 110. FIG. 3 corresponds to a block diagram of the controller 70, for example.

As shown in FIG. 3, the first operation OP1 includes deriving a first value v1 (angle θ) corresponding to the vibration direction of the first movable portion 10M based on a first signal Sg1 obtained from the first fixed electrode 51 and a second signal Sg2 obtained from the second fixed electrode 52. The first signal Sg1 is obtained from, for example, the first detection circuit 75a. The second signal Sg2 is obtained from, for example, the second detection circuit 75b.

For example, the first value v1 (angle θ) is obtained by synchronously detecting the first signal Sg1 and synchronously detecting the second signal Sg2.

As shown in FIG. 3, the first operation OP1 may include synchronously detecting a first function value of the first value v1 (angle θ) and a second function value of the first value v1. The first function value may include, for example, a sine of the first value v1. The second function value may include, for example, a cosine of the first value v1. For example, the first operation OP1 may include synchronously detecting sin θ and cos Θ.

For example, as shown in FIG. 3, the controller 70 may include a first processor 71 and a second processor 72. The first processor 71 is configured to derive the first value v1 (angle θ) based on the first signal Sg1 and the second signal Sg2. The second processor 72 is configured to synchronously detect the first function value (for example, sin θ) and the second function value (for example, cos θ).

As shown in FIG. 3, the first operation OP1 may further include outputting a reference frequency f_{PLL}. The reference frequency f_{PLL} is obtained based on a difference between a first derived value and a second derived value. The first derived value is derived based on a first detection value obtained by synchronous detection of the first function value (for example, sin θ) and a reference phase Φr. The second derived value is derived based on a second detection value obtained by synchronous detection of the second function value (for example, cos θ) and the reference phase Φr.

As shown in FIG. 3, for example, the controller 70 includes a third processor 73. The third processor 73 is, for example, a PLL controller. The third processor 73 (PLL controller) is configured to output the reference frequency f_{PLL}. The third processor 73 may generate the reference phase dr. That is, the first operation OP1 may further include generating the reference phase Φr.

For example, synchronous detection of the first function value (for example, sin θ) and the second function value (for example, cos θ) is performed using the reference phase Φr.

Regarding the first function value (for example, sin θ) and the second function value (for example, cos θ), a calculation with sin Φr and cos Φr is performed. The result of the calculation is processed with a low-pass filter (LPF).

For example, a phase of the angle θ in the vibration direction of the first movable portion 10M is defined as a phase Φ. A difference between the phase Φ and the reference phase Φr is defined as a phase difference δφ. The phase difference δφ is obtained by the result of the above-mentioned low-pass filter processing. The phase difference δφ is input to the third processor 73 (for example, a PLL controller). The third processor 73 is configured to derive the reference frequency f_{PLL} based on the phase difference δφ.

The first operation OP1 may further include outputting the angular velocity Av1 applied to the first element portion 10E based on the reference frequency f_{PLL}. For example, the controller 70 may further include a fourth processor 74. The fourth processor 74 is configured to output the angular velocity Av1. For example, in the fourth processor 74, gain of the reference frequency f_{PLL} may be adjusted. For example, in the fourth processor 74, bias caused by angle dependence in the reference frequency f_{PLL} may be removed. For example, the angular velocity Av1 is obtained by the adjustment.

As described above, in the embodiment, the angle θ of the vibration direction of the first movable portion 10M changes with time. For example, a “virtual rotation mode operation” is implemented. At this time, the angle θ may change non-uniformly due to, for example, non-uniformity during manufacturing of the first element portion 10E. For example, there may be cases where the vibration direction of the first movable portion 10M tends to be in a certain direction and difficult to vibrate in another direction. For example, an “angle dependent bias” occurs. In such a case, by performing the first operation OP1 as described above, the influence of the non-uniformity of the angle θ can be suppressed. According to the embodiment, it is possible to provide a sensor that can improve detection accuracy.

For example, in the operation of changing the angle θ with time, the influence of non-uniformity of the angle θ can be suppressed by combining synchronous detection of the angle θ in the vibration direction and PLL control. For example, the influence of non-uniformity of angle θ can be suppressed in real time.

For example, in the “virtual rotation mode operation”, a reference example may be considered in which the measured value of the angle-dependent bias is corrected by curve fitting to suppress the influence of the angle-dependent bias. In the embodiment, the influence of angle-dependent bias can be suppressed with higher accuracy than in the reference example. Furthermore, in the embodiment, the effects of angle-dependent bias can be suppressed more effectively by processing in real time.

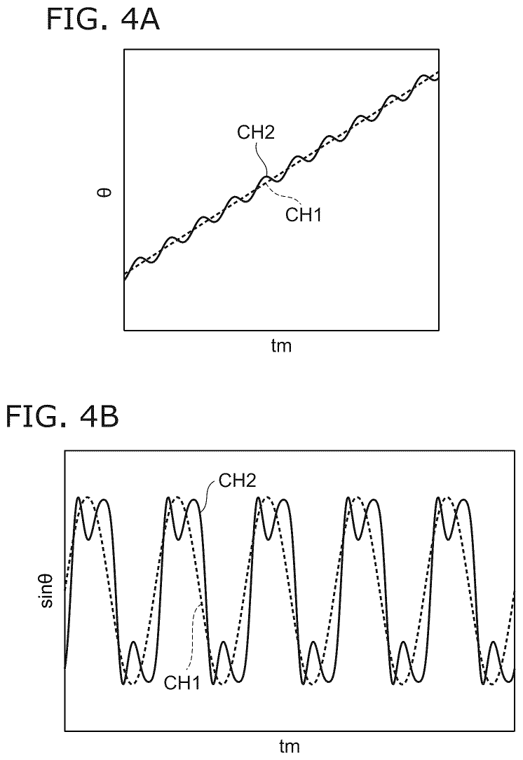

FIGS. 4A and 4B are graphs illustrating the operation of the sensor according to the first embodiment.

In these figures, a first characteristic CH1 and a second characteristic CH2 are illustrated. In the first characteristic CH1, the accuracy of the first element portion 10E is very high. In the first characteristic CH1, substantially no angle-dependent bias occurs. On the other hand, in the second characteristic CH2, the accuracy of the first element portion 10E is not high. An angle-dependent bias occurs in the second characteristic CH2. The horizontal axis of these figures is time tm. The vertical axis in FIG. 4A is the angle θ. The vertical axis in FIG. 4B is sin θ.

As shown in FIG. 4A, in the first characteristic CH1 in which the first element portion 10E has very high precision, the angle θ changes linearly with time tm. On the other hand, in the second characteristic CH2 where the accuracy of the first element portion 10E is not high, the angle θ shifts from the linear characteristic with the period of the characteristic. As shown in FIG. 4B, in the first characteristic CH1, sin θ changes sinusoidally. On the other hand, in the second characteristic CH2, a harmonic component occurs in sin θ characteristics.

In such a case, by performing the first operation OP1 being above-described, the influence of the non-uniformity of the angle θ can be suppressed. For example, the angle θ changes (rotates) at a specific speed. By changing the angle θ as a function of sine and cosine, the angle θ can be converted into a periodic signal. The frequency of the fundamental wave of the signal corresponds to the angular velocity Av1 of the detection target. The harmonics of the signal correspond to the angle-dependent bias. In the embodiment, the angular velocity Av1 can be obtained by suppressing the influence of non-uniformity of the angle θ by using synchronous detection and PLL control. According to the embodiment, it is possible to provide a sensor that can improve detection accuracy.

For example, the deviation in the temporal change in the angle θ of the vibration direction of the first movable portion 10M due to the first drive signal Sv1 and the second drive signal Sv2 is corrected by the first operation OP1.

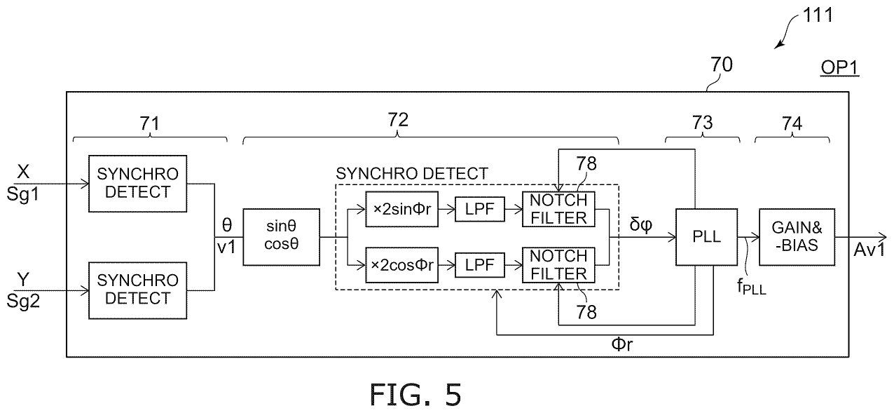

FIG. 5 is a schematic diagram illustrating a part of a sensor according to the first embodiment.

As shown in FIG. 5, in a sensor 111 according to the embodiment, the controller 70 of the first circuit portion 70C includes a notch filter 78. The configuration of the sensor 111 except for this may be the same as the configuration of the sensor 110.

The notch filter 78 is configured to filter the first detection value obtained by synchronous detection of the first function value (for example, sin θ) and the second detection value obtained by synchronous detection of the second function value (for example, cos θ) based on the reference frequency f_{PLL}. For example, the reference frequency f_{PLL} is supplied to the notch filter 78 from the third processor 73 (for example, a PLL controller). The notch filter 78 attenuates, for example, a component of the reference frequency f_{PLL} of the first detection value obtained by synchronous detection of the first function value (for example, sin θ). The notch filter 78 attenuates, for example, a component of the reference frequency f_{PLL} of the second detection value obtained by synchronous detection of the second function value (for example, cos θ).

For example, the reference frequency f_{PLL} is fed back to the attenuation frequency of the notch filter 78. Thereby, the influence of non-uniformity of the angle θ is suppressed more effectively.

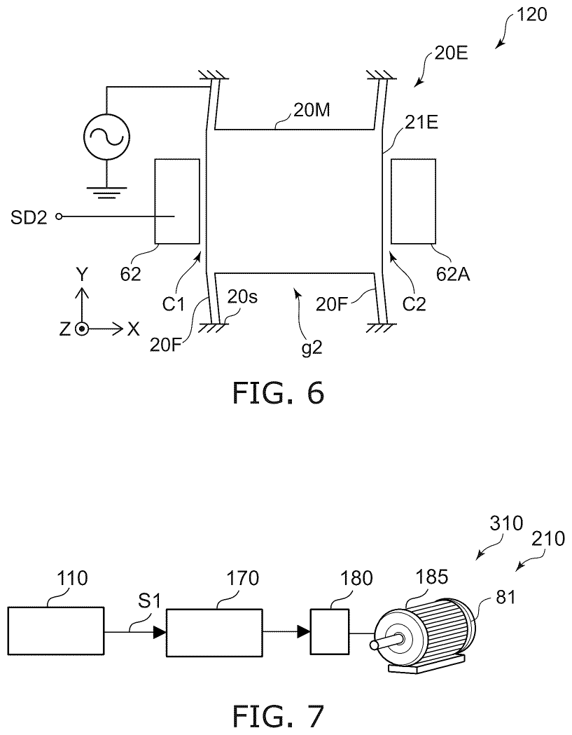

FIG. 6 is a schematic plan view illustrating a part of a sensor according to the first embodiment.

As shown in FIG. 6, a sensor 120 according to the embodiment further includes a second element portion 20E in addition to the first element portion 10E and first circuit portion 70C (see FIG. 1). The configuration described regarding the sensor 110 (and sensor 111) can be applied to the configuration of the first element portion 10E and the first circuit portion 70C.

As shown in FIG. 6, the second element portion 20E includes a second base 20s, a second fixed portion 20F, a second movable portion 20M, and a second element fixed electrode 62. The second fixed portion 20F is fixed to the second base 20s. The second movable portion 20M is supported by the second fixed portion 20F. A second gap g2 is provided between the second base 20s and the second movable portion 20M. The second element fixed electrode 62 is fixed to the second base 20s. A second element portion signal SD2 generated between the second movable portion 20M and the second element fixed electrode 62 changes depending on the acceleration applied to the second element portion 20E.

For example, the second movable portion 20M includes a portion facing the second element fixed electrode 62. A first capacitance C1 is formed between this portion and the second element fixed electrode 62. For example, acceleration can be detected by detecting the first capacitance C1. The second element portion 20E is, for example, an acceleration sensor.

In this example, the second element portion 20E further includes a second element opposing fixed electrode 62A. The second element opposing fixed electrode 62A is fixed to the second base 20s. The second movable portion 20M is provided between the second element fixed electrode 62 and the second element opposing fixed electrode 62A. The second movable portion 20M includes a portion facing the second element opposing fixed electrode 62A. A second capacitance C2 is formed between this portion and the second element opposing fixed electrode 62A. For example, by detecting the difference between a signal based on the first capacitance C1 and a signal based on the second capacitance C2, acceleration can be detected with higher accuracy.

A plurality of second element portions 20E may be provided. A direction from the second movable portion 20M to the second element fixed electrode 62 in one of the plurality of second element portions 20E may crosses a direction from the second movable portion 20M to the second element fixed electrode 62 in another one of the plurality of second element portions 20E. For example, accelerations along a plurality of different directions are detected. For example, the acceleration along the X-axis direction, the acceleration along the Y-axis direction, and the acceleration along the Z-axis direction may be detected.

### Second Embodiment

A second embodiment relates to an electronic device.

FIG. 7 is a schematic diagram illustrating an electronic device according to a second embodiment.

As shown in FIG. 7, an electronic device 310 according to the embodiment includes the sensors according to the first embodiment (sensor 110) and the circuit processor 170. The circuit processor 170 is configured to control a circuit 180 based on the signal S1 obtained from the sensor. The circuit 180 is, for example, a control circuit for a drive device 185. According to the embodiment, for example, the circuit 180 for controlling the drive device 185 can be controlled with high accuracy.

As shown in FIG. 7, the sensor system 210 according to the embodiment includes the sensor (for example, the sensor 110) according to the first embodiment and a detection target member 81. The sensor 110 is fixed to the detection target member 81. The sensor 110 can detect a signal from the detection target member 81.

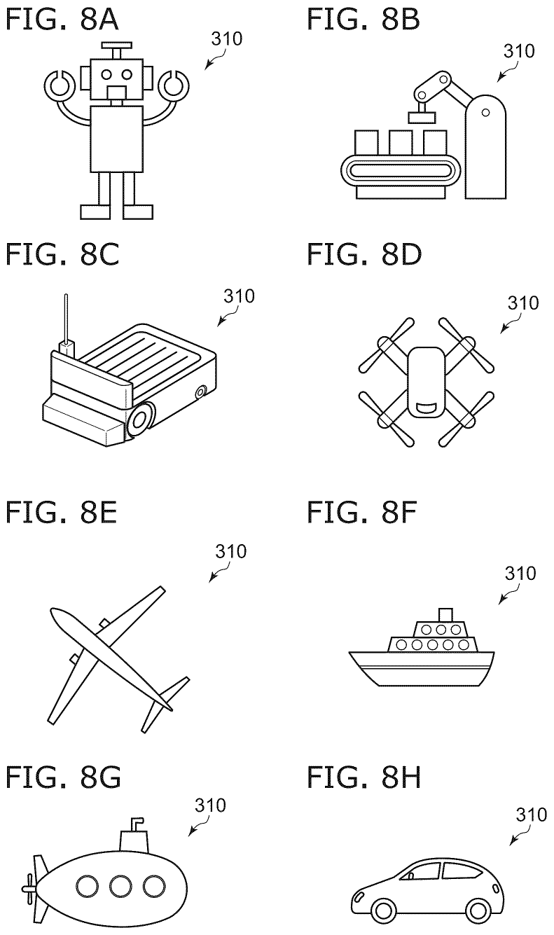

FIGS. 8A to 8H are schematic views illustrating applications of the electronic device according to the embodiment.

As shown in FIG. 8A, the electronic device 310 may be at least a portion of a robot. As shown in FIG. 8B, the electronic device 310 may be at least a portion of a machining robot provided in a manufacturing plant, etc. As shown in FIG. 8C, the electronic device 310 may be at least a portion of an automatic guided vehicle inside a plant, etc. As shown in FIG. 8D, the electronic device 310 may be at least a portion of a drone (an unmanned aircraft). As shown in FIG. 8E, the electronic device 310 may be at least a portion of an airplane. As shown in FIG. 8F, the electronic device 310 may be at least a portion of a ship. As shown in FIG. 8G, the electronic device 310 may be at least a portion of a submarine. As shown in FIG. 8H, the electronic device 310 may be at least a portion of an automobile. The electronic device 310 may include, for example, at least one of a robot or a moving body.

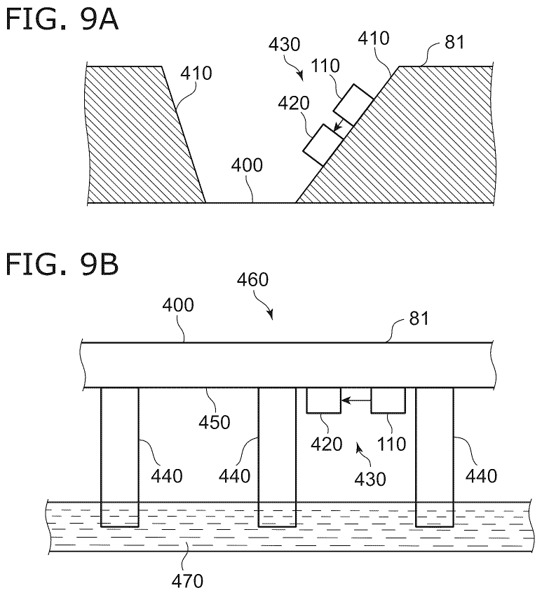

FIGS. 9A and 9B are schematic views illustrating applications of the sensor according to the embodiment.

As shown in FIG. 9A, a sensor 430 according to the fifth embodiment includes the sensor according to one of the first to third embodiments, and a transmission/reception part 420. In the example of FIG. 9A, the sensor 110 is illustrated as the sensor. The transmission/reception part 420 is configured to transmit the signal obtained from the sensor 110 by, for example, at least one of wireless and wired methods. The sensor 430 is provided on, for example, a slope surface 410 such as a road 400. The sensor 430 can monitor the state of, for example, a facility (e.g., infrastructure). The sensor 430 may be, for example, a state monitoring device.

For example, the sensor 430 detects a change in the state of a slope surface 410 of a road 400 with high accuracy. The change in the state of the slope surface 410 includes, for example, at least one of a change in the inclination angle and a change in the vibration state. The signal (inspection result) obtained from the sensor 110 is transmitted by the transmission/reception part 420. The status of a facility (e.g., infrastructure) can be monitored, for example, continuously.

As shown in FIG. 9B, the sensor 430 is provided, for example, in a portion of a bridge 460. The bridge 460 is provided above the river 470. For example, the bridge 460 includes at least one of a main girder 450 and a pier 440. The sensor 430 is provided on at least one of the main girder 450 and the pier 440. For example, at least one of the angles of the main girder 450 and the pier 440 may change due to deterioration or the like. For example, the vibration state may change in at least one of the main girder 450 and the pier 440. The sensor 430 detects these changes with high accuracy. The detection result can be transmitted to an arbitrary place by the transmission/reception part 420. Abnormalities can be detected effectively.

The embodiments may include the following Technical proposals:

### (Technical Proposal 1)

A sensor, comprising:
a first element portion; and
a first circuit portion,
the first element portion includes:
   a first base,
   a first fixed portion fixed to the first base,
   a first movable portion supported by the first fixed portion, a first gap being provided between the first base and the first movable portion, the first movable portion including a first movable electrode, a second movable electrode, a third movable electrode and a fourth movable electrode;
   a first fixed electrode fixed to the first base and facing the first movable electrode,
   a second fixed electrode fixed to the first base and facing the second movable electrode;
   a third fixed electrode fixed to the first base and facing the third movable electrode, and
   a fourth fixed electrode fixed to the first base and facing the fourth movable electrode;
a second direction from the first fixed electrode to the first fixed portion crossing a first direction from the first base to the first fixed portion,
a third direction from the second fixed electrode to the first fixed portion crossing the first direction and crossing the second direction,
a direction from the first fixed portion to the third fixed electrode being along the second direction,
a direction from the first fixed portion to the fourth fixed electrode being along the third direction,
the first circuit portion including a controller,
the controller being configured to perform a first operation,
the first operation including:
   deriving a first value corresponding to a vibration direction of the first movable portion based on a first signal obtained from the first fixed electrode and a second signal obtained from the second fixed electrode, and
   synchronously detecting a first function value of the first value and a second function value of the first value.

### (Technical Proposal 2)

The sensor according to Technical proposal 1, wherein
the first function value includes a sine of the first value, and
the second function value includes a cosine of the first value.

### (Technical Proposal 3)

The sensor according to Technical proposal 1 or 2, wherein
the third direction is substantially perpendicular to the second direction.

### (Technical Proposal 4)

The sensor according to any one of Technical proposals 1-3, wherein
the first circuit portion further includes a first detection circuit and a second detection circuit,
the first detection circuit is electrically connected to the first fixed electrode and configured to output the first signal, and
the second detection circuit is electrically connected to the second fixed electrode and configured to output the second signal.

### (Technical Proposal 5)

The sensor according to any one of Technical proposals 1-4, wherein
the controller includes a first processor and a second processor,
the first processor is configured to derive the first value based on the first signal and the second signal, and
the second processor is configured to synchronously detect the first function value and the second function value.

### (Technical Proposal 6)

The sensor according to any one of Technical proposals 1-5, wherein
the first operation further includes outputting a reference frequency,
the reference frequency is obtained based on a difference between a first derived value and a second derived value,
the first derived value is derived based on a first detection value obtained by a synchronous detection of the first function value and a reference phase, and
the second derived value is derived based on a second detection value obtained by a synchronous detection of the second function value and the reference phase.

### (Technical Proposal 7)

The sensor according to Technical proposal 6, wherein
the first operation further includes generating the reference phase.

### (Technical Proposal 8)

The sensor according to Technical proposal 6 or 7, wherein
the controller further includes a third processor, and
the third processor includes a PLL controller configured to output the reference frequency.

### (Technical Proposal 9)

The sensor according to any one of Technical proposals 6-8, wherein
the synchronous detection of the first function value and the second function value is performed using the reference phase.

### (Technical Proposal 10)

The sensor according to any one of Technical proposals 6-9, wherein
the first operation further includes outputting an angular velocity applied to the first element portion based on the reference frequency.

### (Technical Proposal 11)

The sensor according to Technical proposal 10, wherein
the controller further includes a fourth processor, and
the fourth processor is configured to output the angular velocity.

### (Technical Proposal 12)

The sensor according to any one of Technical proposals 6-11, wherein
the controller further includes a notch filter,
the notch filter is configured to filter the first detection value obtained by the synchronous detection of the first function value and the second detection value obtained by the synchronous detection of the second function value based on the reference frequency.

### (Technical Proposal 13)

The sensor according to any one of Technical proposals 1-12, wherein
the first circuit portion further includes a first drive circuit and a second drive circuit,
the first drive circuit is configured to supply a first drive signal to the third fixed electrode,
the second drive circuit is configured to supply a second drive signal to the fourth fixed electrode, and
the first movable portion is configured to vibrate in response to the first drive signal and the second drive signal.

### (Technical Proposal 14)

The sensor according to Technical proposal 13, wherein
the vibration direction of the first movable portion changes with time.

### (Technical Proposal 15)

The sensor according to Technical proposal 14, wherein
a deviation of a temporal change in an angle of the vibration direction of the first movable portion caused by the first drive signal and the second drive signal is corrected by the first operation.

### (Technical Proposal 16)

The sensor according to any one of Technical proposals 1-15, wherein
the first element portion further includes a first connecting portion, a second connecting portion, a third connecting portion, and a fourth connecting portion,
the first connecting portion is supported by the first fixed portion and supports the first movable portion,
the second connecting portion is supported by the first fixed portion and supports the first movable portion,
the third connecting portion is supported by the first fixed portion and supports the first movable portion,
the fourth connecting portion is supported by the first fixed portion and supports the first movable portion,
the first connecting portion is provided between the first fixed portion and the first movable portion in the second direction,
the second connecting portion is provided between the first fixed portion and the first movable portion in the third direction,
the third connecting portion is provided between the first fixed portion and the first movable portion in the second direction, and
the fourth connecting portion is between the first fixed portion and the first movable portion in the third direction.

### (Technical Proposal 17)

The sensor according to any one of Technical proposals 1-16, further comprising:
a second element portion,
the second element portion includes:
   a second base,
   a second fixed portion fixed to the second base,
   a second movable portion supported by the second fixed portion, and
   a second element fixed electrode fixed to the second base,
a second element signal generated between the second movable portion and the second element fixed electrode changes in response to acceleration applied to the second element portion.

### (Technical Proposal 18)

The sensor according to Technical proposal 17, wherein
the second element portion is an acceleration sensor.

### (Technical Proposal 19)

The sensor according to Technical proposal 17 or 18, wherein
a plurality of the second element portions are provided,
a direction from the second movable portion to the second element fixed electrode in one of the plurality of second element portions crosses a direction from the second movable portion to the second element fixed electrode in another one of the plurality of second element portions.

### (Technical Proposal 20)

An electronic device, comprising:
the sensor according to any one of Technical proposals 1-19; and
a circuit controller configured to control a circuit based on a signal obtained from the sensor.

According to the embodiment, a sensor and electronic device can be provided that can improve detection accuracy.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the sensors such as element portions, bases, fixed portions, movable portions, fixed electrodes, circuit portions, controllers etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors and all electronic devices practicable by an appropriate design modification by one skilled in the art based on the sensors and the electronic devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a first element portion; and
a first circuit portion,
the first element portion includes:
a first base,
a first fixed portion fixed to the first base,
a first movable portion supported by the first fixed portion, a first gap being provided between the first base and the first movable portion, the first movable portion including a first movable electrode, a second movable electrode, a third movable electrode and a fourth movable electrode;
a first fixed electrode fixed to the first base and facing the first movable electrode,
a second fixed electrode fixed to the first base and facing the second movable electrode;
a third fixed electrode fixed to the first base and facing the third movable electrode, and
a fourth fixed electrode fixed to the first base and facing the fourth movable electrode;
a second direction from the first fixed electrode to the first fixed portion crossing a first direction from the first base to the first fixed portion,
a third direction from the second fixed electrode to the first fixed portion crossing the first direction and crossing the second direction,
a direction from the first fixed portion to the third fixed electrode being along the second direction,
a direction from the first fixed portion to the fourth fixed electrode being along the third direction,
the first circuit portion includes a controller,
the controller being configured to perform a first operation,
the first operation including:
deriving a first value corresponding to a vibration direction of the first movable portion based on a first signal obtained from the first fixed electrode and a second signal obtained from the second fixed electrode, and
synchronously detecting a first function value of the first value and a second function value of the first value.

2. The sensor according to claim 1, wherein
the first function value includes a sine of the first value, and
the second function value includes a cosine of the first value.

3. The sensor according to claim 1, wherein
the third direction is substantially perpendicular to the second direction.

4. The sensor according to claim 1, wherein
the first circuit portion further includes a first detection circuit and a second detection circuit,
the first detection circuit is electrically connected to the first fixed electrode and configured to output the first signal, and
the second detection circuit is electrically connected to the second fixed electrode and configured to output the second signal.

5. The sensor according to claim 1, wherein
the controller includes a first processor and a second processor,
the first processor is configured to derive the first value based on the first signal and the second signal, and
the second processor is configured to synchronously detect the first function value and the second function value.

6. The sensor according to claim 1, wherein
the first operation further includes outputting a reference frequency,
the reference frequency is obtained based on a difference between a first derived value and a second derived value,
the first derived value is derived based on a first detection value obtained by a synchronous detection of the first function value and a reference phase, and
the second derived value is derived based on a second detection value obtained by a synchronous detection of the second function value and the reference phase.

7. The sensor according to claim 6, wherein
the first operation further includes generating the reference phase.

8. The sensor according to claim 6, wherein
the controller further includes a third processor, and
the third processor includes a PLL controller configured to output the reference frequency.

9. The sensor according to claim 6, wherein
the synchronous detection of the first function value and the second function value is performed using the reference phase.

10. The sensor according to claim 6, wherein
the first operation further includes outputting an angular velocity applied to the first element portion based on the reference frequency.

11. The sensor according to claim 10, wherein
the controller further includes a fourth processor, and
the fourth processor is configured to output the angular velocity.

12. The sensor according to claim 6, wherein
the controller further includes a notch filter,
the notch filter is configured to filter the first detection value obtained by the synchronous detection of the first function value and the second detection value obtained by the synchronous detection of the second function value based on the reference frequency.

13. The sensor according to claim 1, wherein
the first circuit portion further includes a first drive circuit and a second drive circuit,
the first drive circuit is configured to supply a first drive signal to the third fixed electrode,
the second drive circuit is configured to supply a second drive signal to the fourth fixed electrode, and
the first movable portion is configured to vibrate in response to the first drive signal and the second drive signal.

14. The sensor according to claim 13, wherein
the vibration direction of the first movable portion changes with time.

15. The sensor according to claim 14, wherein
a deviation of a temporal change in an angle of the vibration direction of the first movable portion caused by the first drive signal and the second drive signal is corrected by the first operation.

16. The sensor according to claim 1, wherein
the first element portion further includes a first connecting portion, a second connecting portion, a third connecting portion, and a fourth connecting portion,
the first connecting portion is supported by the first fixed portion and supports the first movable portion,
the second connecting portion is supported by the first fixed portion and supports the first movable portion,
the third connecting portion is supported by the first fixed portion and supports the first movable portion,
the fourth connecting portion is supported by the first fixed portion and supports the first movable portion,
the first connecting portion is provided between the first fixed portion and the first movable portion in the second direction,
the second connecting portion is provided between the first fixed portion and the first movable portion in the third direction,
the third connecting portion is provided between the first fixed portion and the first movable portion in the second direction, and
the fourth connecting portion is between the first fixed portion and the first movable portion in the third direction.

17. The sensor according to claim 1, further comprising:
a second element portion,
the second element portion includes:
a second base,
a second fixed portion fixed to the second base,
a second movable portion supported by the second fixed portion, and
a second element fixed electrode fixed to the second base,
a second element signal generated between the second movable portion and the second element fixed electrode changes in response to acceleration applied to the second element portion.

18. The sensor according to claim 17, wherein
the second element portion is an acceleration sensor.

19. The sensor according to claim 17, wherein
a plurality of the second element portions are provided,
a direction from the second movable portion to the second element fixed electrode in one of the plurality of second element portions crosses a direction from the second movable portion to the second element fixed electrode in another one of the plurality of second element portions.

20. An electronic device, comprising:
the sensor according to claim 1; and
a circuit controller configured to control a circuit based on
a signal obtained from the sensor.
